(19) United States
(12) Patent Application Publication
(10) Pub. No.: US 2002/0103822 A1
(43) Pub. Date: Aug. 1, 2002

(54) Method and system for customizing an object for downloading via the internet

(76) Inventor: Isaac Miller, Givatayim (IL)

Correspondence Address: BROWDY AND NEIMARK, P.L.L.C., 624 Ninth Street, N.W., Washington, DC, 20001, US

(21) Appl. No.: 09/773,367

(22) Filed: Feb. 1, 2001

(30) Foreign Application Priority Data
Feb. 1, 2001 (IL) 134319

(51) Int. Cl. G06F 17/21

(52) U.S. Cl. 707/501.1

(57) ABSTRACT

A computer-implemented method and system for downloading a customized base object to a client machine, wherein a Content Provider web server obtains an enhanced object created from the base object, the enhanced object having associated therewith an identification for allowing an agent web server to uniquely identify it, and having embedded therein program code for effecting communication with the agent web server. The Content Provider web server downloads to a client machine an XHTML page containing a reference to the enhanced object so as to allow activation of the program code by the client machine and thereby to call the agent web server, so as to allow the agent web server to download auxiliary data to the client machine in predetermined association with the enhanced object within a boundary thereof.

### FIELD OF THE INVENTION

This invention relates to a method for customizing a visual object downloaded over the Internet.

### BACKGROUND OF THE INVENTION

It has long been accepted that one of the means to attract users to web sites is by offering them reach and useful content. Visualization (graphics, animation and video) has long been recognized as an efficient mean for conveying information. Graphics, in particular, are considered very useful and efficient in achieving this goal. Graphics (e.g. photos, illustrations) are relatively less demanding in terms of bandwidth, which results in faster appearance to the user. Such graphics may be used to present products and to explain how to accomplish tasks; for example, a series of images may be used to describe a plumbing project that would be difficult to explain using text alone. The user has time to inspect the image and grasp its full content. The user can interact with the image in order to reveal more explanatory data, or alternatively, can take the time to develop interest in a product based on the product qualities and aesthetics as they emerge from the still image. To this end, creators of animation or even video clips may wish to halt the clips on the first frame to let the viewer grasp an initial impression, allowing him to start playing the clip at his will. Similarly, the clip's last frame which stays still on the user's screen (unless the clip disappears or loops back to start) provides the user with another perspective into what has been previously demonstrated. In the specification and appended claims, graphics and graphics objects relate particularly to still images such as XHTML's IMG objects, but are also intended to include those potential video or animation halted first and last frames. Throughout the specification and appended claims, the term XHTML is used to denote HTML, XML or the recent W3C recommended XHTML format.

Web site designers have long recognized that it is more attractive for viewers to be able to see several images or additional text relating to the theme of a web page, or relating to the specific theme of some graphics, without the need to load each time a different page. One design scheme is to replace an image by another one in consequence to user interaction such as mouse-click on some button or some region on the image. Successive mouse clicks result in displaying successive new images cyclically. Another design scheme is to temporarily swap an image by another image as a result of user interaction, such as during mouse-over on a button or image map region in the first image. According to a special case of this interaction, the first image is not totally obscured by a new one. Rather, a smaller image (a picture or a text box) is shown on top of the first image. This overlaying has an interesting effect of showing a particular piece of information (textual or visual) which is contextually related to the underlying picture. As an example, consider an image of a car wheel overlaid on top of an image of the car interior (the wheel in the overlay picture is enlarged relative to the wheel in the base object). In order to enhance the entertaining effect on the viewers, web designers strive to use different graphical effects for these overlaying schemes. For example, they would like the overlay picture or text to fade out gradually thus fully exposing the underlying base object.

Content providers have realized the potential of overlaying not only still images or texts but also animations and video clips. One attractive usage is an animation-based advertisement. As opposed to an advertisement banner, whose location on the page is predictable and can easily be ignored by the viewer, an advertisement, which starts playing right inside an image that is part of the page content is eye catching. Moreover, content providers (or their affiliates) can choose to run promotional materials, which are highly related to the theme conveyed by the image or part of it. This in turn makes it more likely to match a user's interest than a regular ad banner These design schemes bring benefit to site designers as well. Once the size of the base object is set, a designer has no need to modify the page layout as a result of overlaid information, which is displayed on top of the base object and within its boundary but is not itself part of the base object. Finally, viewers also appreciate these design schemes. First, the pages are less crowded—a single image may suffice with all other pieces of information displaying in the same region. Secondly, the images or illustrations seem to have more content than at first appreciated. This, in addition to the interaction involved, make those graphics more viable and entertaining—an issue regarded as highly important by site designers.

Yet, current tools are not adequate for constructing these schemes. DHTML and JavaScript that are commonly used for this purpose require substantial effort. It requires coding the swap functionality and the event response for each hot spot. Since DHTML does not support image overlapping (or any kind of merging for that matter), in the case of “smaller image on top of a larger image” mode, it requires complex image puzzle and swap code to achieve the desired visualization. Also, it is almost impossible for these tools to produce any non-trivial insertion effect of one image on top of the other. Moreover, the author needs to supply a double set of images for the “mouse-over” (the “on”) set and for the “mouse-out” (the “off”) set with the respective “on” and “off” visualization. In addition, in spite of recognizing the potential of animation as a very entertaining and compelling medium, site designers rarely used animations for an overlaid object. This is due in part to the fact that DHTML and JavaScript are pretty much limited in their animation power. Several other tools are available that support better graphical effects and animations. For example, Java applets are available that merge two images in a fashion similar to that found in Microsoft's PowerPoint. Microsoft and PowerPoint are registered trademarks of Microsoft Corporation, Redmond, USA. In addition, Macromedia's Flash is becoming very popular for vector based animations on the Web. Macromedia and Macromedia Flash are registered trademarks of Macromedia, Inc. San Francisco, USA. Yet, site designers feel that there is lacking a mechanism to tailor such tools in order to easily configure a combined overlay scheme. For example, it is not possible to combine the Java code for producing graphical insertion effects into Flash. Also it requires detailed authoring to create a timely overlaid sequence of images and animations with the desired hot spot mapping and reaction visualization.

U.S. Pat. No. 5,907,837 (Ferrel et al.) discloses an information retrieval system in an on-line network including separate content and layout of published titles. Within a section of a title, a designer can layout pages with controls that define areas for content to be inserted into the pages. Two commonly used controls in the system are a static story control, wherein a preselected story is statically placed on a page in the area defined by the control, and a dynamic story control, wherein the designer defines search objects to retrieve stories. An information retrieval (IR) server indexes and searches stories in titles. Indexing takes place when a title is released to the network by a publisher workstation. The IR server interrelates title, section and story objects by their globally unique identifiers and creates a routing table that is used to locate objects across multiple database partitions. The IR search service is requested in two different ways at customer runtime. The first way is the resolution of the search objects to retrieve matching stories. The retrieved stories are concatenated and poured into the area defined by the dynamic control when the title is viewed. In the second way, the IR search service is requested when a search is initiated by a customer using a “find” dialog to search across all stories in one or more titles, both dynamic and static.

This reference appears to relate to a system for retrieving information, while the present invention relates primarily to a web-based system for downloading data to an end-user, both of which require quite different techniques for implementing design and content separation. Moreover, U.S. Pat. No. 5,907,837 does not address the manner in which the object is modified prior to being downloaded to a targeted end-user.

U.S. Pat. No. 5,948,061 (Merriman et al.) assigned to Double Click, Inc., discloses a method of delivery, targeting, and measuring advertising over a network such as the Internet. Statistics are compiled on individual users and networks and the use of the advertisements is tracked to permit targeting of the advertisements of individual users. In response to requests from affiliated sites, an agent server transmits to people accessing the page of a site an appropriate one of the advertisement based upon profiling of users and networks.

U.S. Pat. No. 5,794,210 (Goldhaber et al.) discloses a system that allows advertisers to detach their messages from program content and explicitly target their audience. Targeting users may be provided by reference to a data base of digitally stored demographic profiles of potential users. Competing advertisers may “bid” for the attention of users using automatic electronic systems, e.g., “an auction” protocol and these concepts can be generalized to provide an electronic trading house where buyers and sellers can actively find each other and negotiate transactions. At col. 7, line 21 there is provided an example of a hypothetical surfer called “Cynthia” who is presented with a list of pre-selected ads that she may elect to view, based on a personal profile questionnaire that she filled in previously and automatic tracking of her previous Internet usage. The ads are not only keyed to Cynthia's interests, but certain aspects of their style, depth and content can also be customized to her as well. For example, her love of sunsets (as previously determined) can be used to customize ads so that they will have more appeal for her. It appears that the customization is based on the existence of already prepared ads, which just happen to address her personal profile and tracking history. There is no suggestion that the customization be performed in real time, nor is any mechanism for doing so presented. Moreover, this reference too does not relate to an actual mechanism in which an ad banner is modified.

The only customization mechanism that can be assumed based on the description, is where the ads have been pre-created and pre-selected for “Cynthia” according to her interests and tracking history. Thus, at col. 15, lines 26, 27 there is given by way of example an attention brokerage server that stores a repertoire of ads relating to skiing. For example, this might be achieved by the advertising company building various kinds of ads: one with sunsets (for romantic girls, like Cynthia), one with sports cars (for sports freaks) and one with building blocks (for children). The advertisements already exist and the “customization” merely extends to downloading the first one to Cynthia. Such matching is thus pre-conceived and requires the prior construction of a library of ads each catering to different interests. How this may be achieved efficiently is not discussed.

U.S. Pat. No. 5,794,210 also employs agents for preparing ads, and as stated at col. 14, lines 59ff, these work off-line and prepare the ads before the surfer logs on. Thus, the agent works round the clock, searching out and screening new ads to find ones that match the surfer's interest. It is stated at col. 14, line 64 that if the agent finds an ad that the surfer does not like, it takes the surfer's feedback and modifies its behavior accordingly. Mention is also made of a salesman, this being an agent who works on behalf of an ad itself and searches out potentially interested viewers for bringing the ad to their attention, after first securing approval from the surfers' personal agents. However, no mechanism is taught as to how to modify the appearance of a graphics object prior to downloading to the client.

It would clearly be desirable to have a system that minimizes the authoring burden of prior art overlay schemes. Such an improved system would allow the user to concentrate only on defining the hot spots and their respective activation actions as well as specifying the elements of insertion and its insertion properties (graphical effects). The system itself would then create all the necessary playing mechanisms, the graphical insertion effects, and sensitivity visualization effects, automatically. Existing prior art approaches fall short of these requirements.

Although the design schemes described so far are beneficial for many applications, they are not flexible enough. There are cases when a content provider requires that different viewers of a certain image receive different graphics overlay schemes. For example, a content provider may wish to present one user with additional data regarding the mechanical properties of a product, while presenting another viewer with the elegance and ease of use properties of the product. Also, consider the content provider who wishes to play a promotional animation clip at the bottom of an image. The content provider, however, may wish to play a different advertisement clip for different users. Even if the same clip is to be played regardless of the user, the content provider may still wish to change the promotion clip from time to time with minimal effort. Finally, consider the case of a manufacturer who supplies its product images to its web retailers, be they on-line or off-line with on-line presentation. The manufacturer may wish to have an overlay technical data stored in one place that is reflected through the product image in the web pages of all its web retailers. The manufacturer also wishes to be able to update or fix erroneous data in the overlaid data, having the modified version automatically available on the web retailers' sites. However, it is difficult to manage this kind of customizations and modifications with existing tools. The reason is that according to current methods the overlay data and its insertion pattern is tightly defined together with the base object, all compiled in the same web page. It would therefore be advantageous for such overlay management systems to allow definition of the overlay data externally from the base graphics and in a manner that would enable it later to dynamically send different overlay data based on predefined criteria.

An ubiquitous business model on the Internet today, is for a content provider to lend space on its pages for advertising. According to this model, an advertising broker receives payment by an advertiser for “pushing” advertisements into the content provider's space, paying the content provider a fee (equal to the advertiser's charge less a commission to the broker). Realizing the image overlay scheme as a new advertisement channel, content providers may wish to “lend” their images to their business affiliates or even to a third party advertisement broker for the sake of dynamically inserting advertisement material into their images. However, care should be taken, in this case. Standard ad banners come as “outside the page context” and consequently can display advertisement that is not related to the page content. An advertisement that displays inside an image, however, can be effective only if it is contextually related to the theme of the image (or to part of it) or at least not in contextual conflict with it. Moreover, the advertisement also must not be in contextual conflict with the theme of the page (or even the site) in which the image is positioned. Just the same, the content provider must ensure that the inserted material does not harm the image or the reputation of its proprietor, nor the context of the page and site. To accomplish such contextual matching, it is desirable that a system that manages such “In Image” advertisements, will allow for category tagging the target images (and the image parts) and will allow for matching advertisement to images based on tag matching. Finally, such a system should be able to collect accounting data about the inserted advertisement such as what ads have been streamed to which image etc.

### SUMMARY OF THE INVENTION

It is a principal object of this invention to provide a mechanism for effectively defining and managing on-line visual overlay schemes.

It is a second object of this invention to provide the capability to target and manage advertising on top of images based on contextual match.

It is third object of this invention to provide measurement tools for images and overlay data exposure.

These objects are realized in accordance with a broad aspect of the invention by a computer-implemented method for downloading a customized a base object to a client machine, said method including the following steps all carried out by a Content Provider web server:

(a) obtaining an enhanced object created from the base object, said enhanced object having associated therewith an identification for allowing an agent web server to uniquely identify said enhanced object, and having embedded therein program code for effecting communication with the agent web server, and

(b) downloading to a client machine an XHTML page containing a reference to the enhanced object so as to allow activation of said program code by the client machine and thereby to call the agent web server, so as to allow the agent web server to download auxiliary data to the client machine in predetermined association with the enhanced object within a boundary thereof.

Thus, according to the invention, after downloading an enhanced object for rendering on a user's browser, auxiliary data may be downloaded for display in association with the base object. Typically, the auxiliary data is further information and/or an advertisement that is displayed briefly on top of the base object. During the period that the auxiliary data is displayed, it either fully or partially obscures the base object underneath, or it is translucent with respect thereto. Content providers scan their existing graphics work and identify suitable Graphics Objects for carrying the auxiliary data. For example, a content provider seeking advertising revenue, will decide which advertisers to approach based on the displayed content. For each Graphics Object, a new enhanced Object is then created which contains the original Graphics Object with some additional properties and constitutes an Enhanced Object. The Enhanced Object is rendered by browsers such as Netscape or Explorer typically in identical visual form to the Graphics Object from which it was created, so that the end user sees no difference in its initial appearance. However, the enhanced object is different from the graphics object constituting the base object in that some properties of the graphics object are defined externally (both geometrically and semantically) and in that it contains a behavioral logic and communication mechanism.

To effect such capability in an Internet environment, one or more agent servers are provided for processing the enhanced objects. When used for incorporating advertisements into graphics objects, the agent servers have access to the various advertisements, which may be stored directly on the servers. The agent servers provide authoring and registration services as well as advertisement delivery and accounting services. When used for incorporating explanatory material, such as instructions relating to a base object displaying a set of images or text, the agent servers having access to the explanatory material.

Enhanced objects are created as encapsulated objects (e.g. Java applets or Flash movies) containing both a base object and execution script (e.g. Java code or Flash commands). The script in the enhanced object is processed either natively by the hosting program (e.g. the browser) or through a plug-in. As part of their creation, or later as a separate action, enhanced objects are registered on the servers dedicated to this purpose and are thus made available for accounting and/or carrying advertisements. For example, when a page containing a pre-registered enhanced object is loaded on a user's browser, the enhanced object becomes activated. According to its pre-installed logic, it schedules itself to contact the agent server where it was registered, and identifies itself to that server. The agent server process determines which advertisement to send into which part of the enhanced object, based on the enhanced object's identification and other information passed by the enhanced object. Such information may include the user interaction with the enhanced object so far and the node's IP address. In so doing, the agent server sends the enhanced object a unique session ID in order to differentiate it from other instances of the same enhanced object currently showing on other users' browsers.

In addition, the agent server process may send back a new logic and new part mapping that replaces the enhanced object's initial logic and mapping. The new logic now governs the enhanced object's behavior (e.g. advertisement pulling scheduling) and different advertisements may now be sent on to different parts of the image. Logic and part mapping replacement can be initiated by the enhanced object according to its logic which results in the corresponding replacement being sent by the agent server. Depending on its setting, the original agent server process may forward the enhanced object's initial identification message to another agent server process, usually on a different network node. This second server (or another one if another forwarding step is executed) will finally respond to the enhanced object. Regardless of how many agent server processes are involved in the initial handshaking process, a direct communication between the enhanced object and its final target agent server is established and maintained from that moment on. According to its logic, an enhanced object may react to mouse-over and mouse-click events on advertisements or parts of the underlying image in various ways. This may include supplying additional information, loading a different page on the user's browser, or suspending advertisement altogether.

### BRIEF DESCRIPTION OF THE DRAWINGS

In order to understand the invention and to see how it may be carried out in practice, some preferred embodiments will now be described, by way of nonlimiting example only, with reference to the accompanying drawings, in which:

FIG. 1 is a block diagram showing functionally a system according to the invention;

FIGS. 2a, 2b and 2c are data flow diagrams for explaining how an enhanced object is prepared, and how an auxiliary object is stored;

FIGS. 3a and 3b are data flow diagrams showing creation of regional mapping object during an additional stage in the preparation of another type of auxiliary object;

FIG. 4 is a data flow diagram showing matching of an auxiliary object with the enhanced object during a subsequent stage in the preparation of an enhanced object overlay scheme;

FIGS. 5a, 5b and 5c show data flow during program runtime;

FIGS. 6a to 6e are a flow diagram showing the principal operating steps associated with a method according to the invention carried out by an enhanced object running on client machine;

FIGS. 7a to 7e are a flow diagram showing the principal operating steps associated with a method according to the invention carried out by an agent server process;

FIG. 8 shows pictorially a base object;

FIG. 9 shows pictorially an enhanced object including the base object of FIG. 8 after regional mapping information has been added;

FIG. 10 shows pictorially the enhanced object of FIG. 9 responding to a “mouse over” event; and

FIG. 11 shows pictorially the enhanced object of FIG. 9 as it is rendered during a display of an externally streamed textual advertisement.

### DETAILED DESCRIPTION OF THE INVENTION

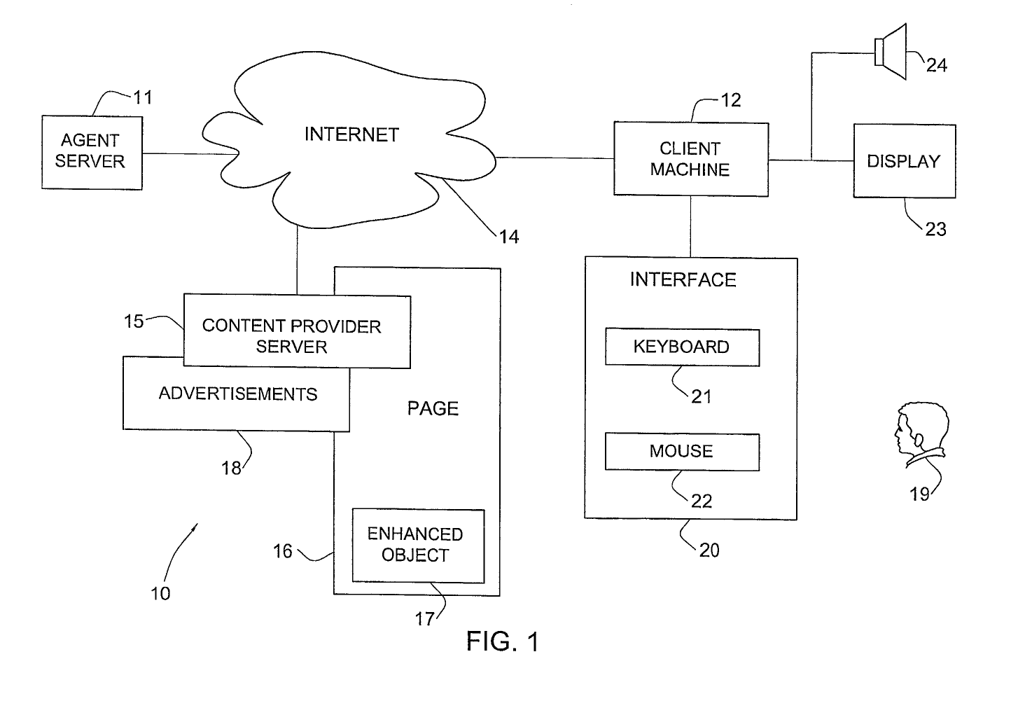

FIG. 1 shows functionally a network 10 comprising at least one web server 11 constituting an “agent server”, a client machine 12 connected via the Internet 14 to the agent server 11. A content provider server 15 stores a page 16 containing reference to at least one enhanced object 17 created by the agent server 11. Stored on the agent server 11 are advertisements 18, constituting auxiliary data that are required to be sent to the client machine 12 in association with a previously downloaded enhanced object 17. Typically, the advertisements 18 includes visual data which overlays the enhanced object 17, and may also include sound and other effects. A user 19 at the client machine 12 surfs the Internet 14 via a user interface 20, typically including a keyboard 21 and a mouse 22. The client machine 12 is coupled to a display device 23 for displaying visual data. Preferably, the client machine 12 also includes a sound card (not shown) and a loudspeaker 24 in order to be able to output audio data.

Content providers are owners of enhanced objects that may use the agent server in order to feed their own advertisements to be displayed on top of their own enhanced objects. Alternatively, they may contract with the agent server, generally for a fee, in order to permit third party advertisements to be displayed on top of their enhanced objects.

The network 10 employs four types of objects:

i) Base object;

ii) Enhanced object being configured to carry auxiliary objects such as explanatory material or advertisement data;

iii) Enhancement Enabler object, being the component inside an enhanced object that contains both graphical and non-graphical data as well as code for managing that data (“logic”). An existing Enhancement Enabler object may replace itself by loading a new Enhancement Enabler object from the agent server; and

iv) Auxiliary objects that the Enhanced object through its Enhancement Enabler object may load as instructed by its logic. These may be, for example, pre-authored advertisement clips. According to user configuration, Auxiliary Objects may need to undergo some transformation by the agent server in order to make them suitable for transmission into an Enhanced object, and/or in order to add to them graphical/temporal effects.

For the purpose of the invention, an object is any digitally represented object that can be transmitted over a network and can be displayed or visually played on a client machine by some client program. Thus, the visual object may be a body of text or a still (static) image (e.g. JPEG or static GIF). Likewise, it can be an animation clip, a dynamic GIF or a movie clip based, for example, on Macromedia's Flash or Macromedia's Shockwave. The visual object can also be an animation clip based on Apple's QuickTime or a video clip such as produced, for example, by RealNetworks' video clip or Apple's QuickTime video. Preferably, the objects are interactive, whereby clicking inside the area occupied by the object when it is rendered or played back on the client machine triggers some actions such as accessing some web page.

The client machine 12 may be a PC or a hand held device (PDA, notebook, cellular telephone etc.) adapted to run client software, which typically is a Web browser application. Alternatively, the client software may be a special purpose player integrated in the browser as a “plug-in” or a special purpose player application.

According to a preferred embodiment, special code is embedded in the enhanced object, whereby the enhanced object contains not only the visual and/or temporal data, but also the code required to play/render it on the client machine. The rendering/playing may be done within a fixed region, most typically a fixed rectangular region as is generally reserved for an image. Preferably, the region within which the rendering/playing occurs can be resized (in which case the rendered/played object is scaled appropriately to match the new size,). Alternatively, the location of the region in which the rendering/playing occurs may be fixed relative to some enclosing object (such as an XHTML page).

The location of the region in which the rendering/playing occurs is preferably dynamic, such that it can be changed during playing of the object or after its rendering, either automatically or as a result of some user action.

The enhanced object includes the base object, which is embedded inside the enhanced object, in addition to Enhancement Enabler object (‘bootstrap object’) which enables it to communicate with a remote server. It also contains an identification that uniquely identifies it in that server In accordance with a particular preferred embodiment, the following are required from an enhanced object:

When it is initially rendered, or when it is initially played back on a target display, it has the potential to look the same as the base object.

User actions that can be done on the base object (such as clicking a Play button to activate a video playback, or clicking an image in order to jump to a new web page), can also be done on the enhanced object in the same fashion.

The enhanced object is capable of doing other actions either triggered by user events or being self-triggered.

If at any point the client machine goes offline, the enhanced object should continue playing the last content it has, issuing no errors.

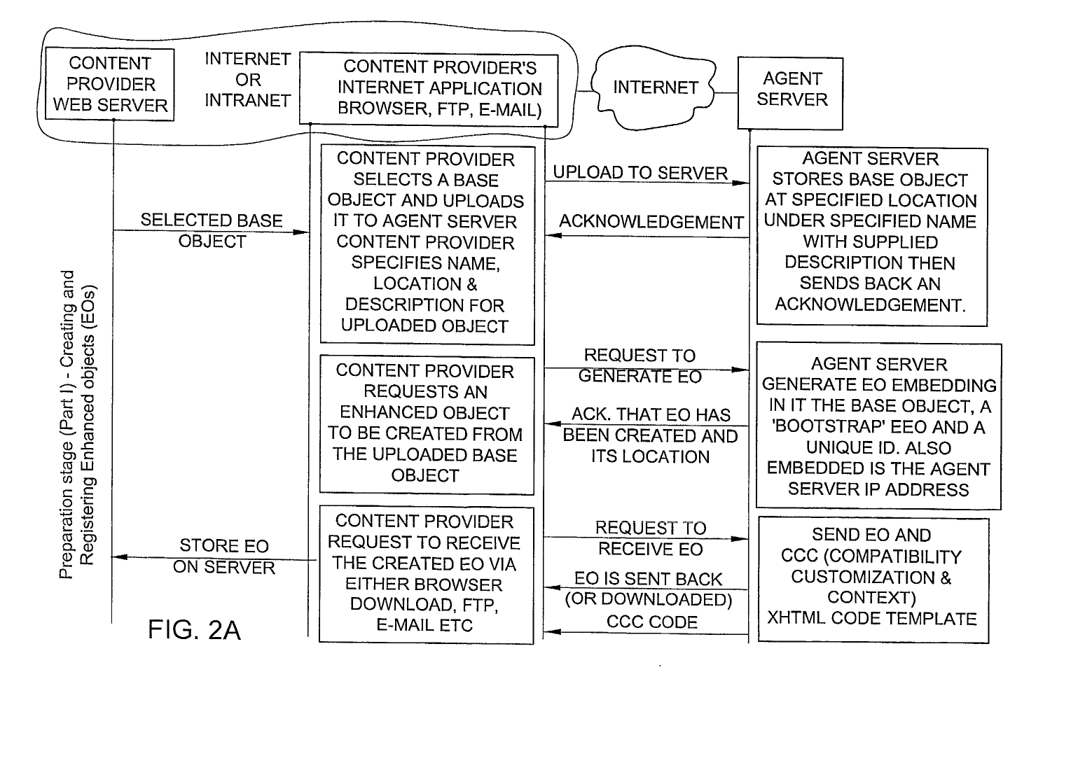

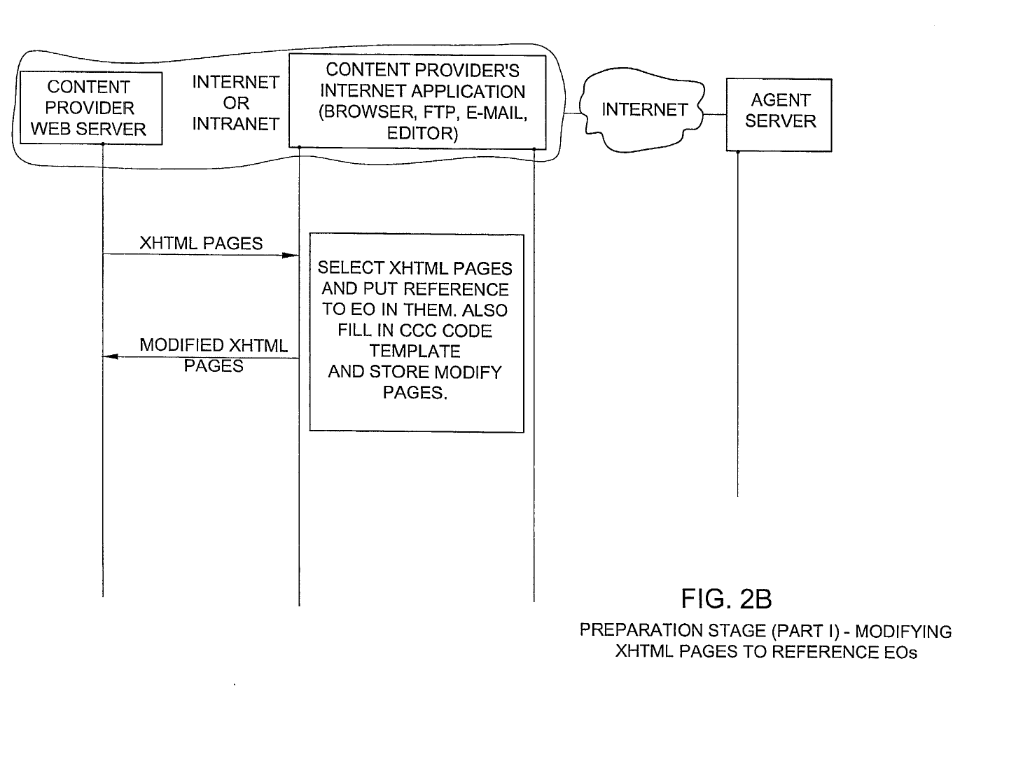

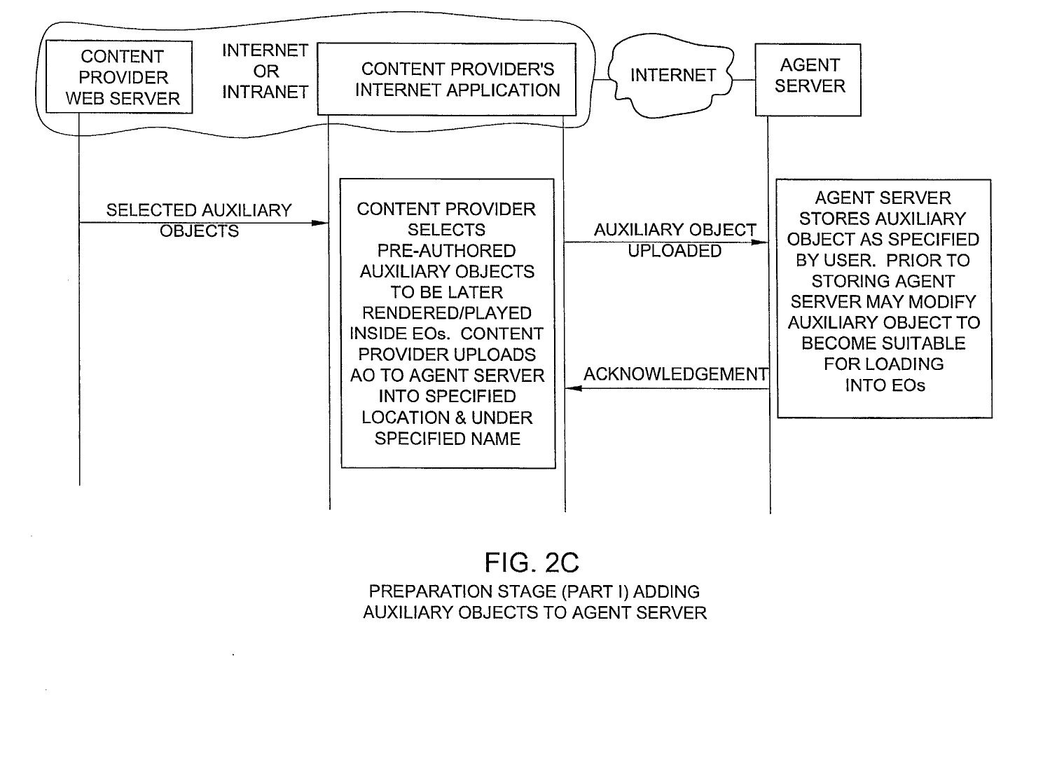

Two distinct and independent processes are required to prepare and run enhanced objects as will now be described with particular regard to FIGS. 2 to 4 and 5, respectively, of the drawings.

Preparation Stage

FIGS. 2a and 2b show the principal flow of data between the agent server 11 and the content provider server 15 for creating and registering an enhanced object.

The Content Provider selects a base object and uploads it to the agent server 11, which store it under a designated name and or identification (user identification) and acknowledges receipt to the Content Provider. The Content Provider may add, either now or at a later stage, descriptive text to be stored along with the base object. Such descriptive text will, in due course, be inherited by the enhanced object derived from the base object. Alternatively, it can be added to the enhanced object after creation. Such text can include category tags that define the content or theme represented by the object and/or by parts of the object and/or by the containing page (if any). Either immediately or subsequently, the Content Provider requests the agent server 11 to create an enhanced object from the previously stored base object. The agent server 11 creates the enhanced object, embedding in it the base object and a unique ID that will later be used by the agency server to identify it. The default dimensions (width and height) of the created enhanced object are set according to the dimensions of the base object. In a preferred embodiment, they are set equal to the dimensions of the base object so that a designer of a web page can easily modify an existing web page containing the base object so as to create a new web page containing the enhanced object. However, it will be appreciated that the dimensions of the enhanced object can, if desired, be set different to those of the base object. Also embedded in the enhanced object is the URL of the agent server 11 and a command to initiate communication with it as soon as it starts playing. The created enhanced object is then sent back to the Content Provider server 15 either through browser download or through FTP or E-mail. A copy of the enhanced object 17 need not be maintained in the agent server 11, but it is very useful to store the associated base object therein. In addition to the enhanced object, the agent server supplies the Content Provider with CCC (Compatibility, Customizing & Context) template XHTML code. The Content Provider stores the created enhanced object on the Content Provider server 15 from which the site pages 16 are to be served. The Content Provider also stores on the same Content Provider server 15 the base object (preferably in some association to the location in which the enhanced object 17 was stored). The Content Provider then puts a reference to the enhanced object 17 in one or more web pages 16 on the site. The Content Provider also puts around the enhanced object the CCC code (setting the customizing and context ID values as he/she sees fit).

In addition to determining the enhanced object's dimensions, the base object is used as the default object in the event that (i) incompatibility with the client machine's web browser prevents rendering of the enhanced object, or (ii) there is faulty communication to the agent server accessed by the enhanced object, or (iii) no data has yet been sent to the agent server in respect of an enhanced object, so that any referrals thereto cannot be addressed.

The Content Provider may refrain from supplying a base object at all. Instead, the Content Provider may specify the desired dimensions of the enhanced object, and the agent server then automatically creates a suitable default base object according to the supplied dimensions. In this case, the agent server also supplies the Content Provider with the created default base object.

With reference to FIG. 2c, in addition to creating and registering enhanced objects on the agent server, the Content Provider may wish to upload auxiliary objects which will be later transmitted into the enhanced object and will be played/rendered inside the enhanced object's containment region. As with base objects, such auxiliary objects may be still images, or animation or video clips. Thus, using either a web browser, or FTP or E-mail application, the Content Provider uploads such objects to the agent server 11. Either after loading these auxiliary objects or prior to loading them, the Content Provider may configure them to be interactive or not. By “interactive” is meant that they have the capability to at least request a new Web page load in a response to a mouse click Oust like standard ad banner). The auxiliary object can also be interactive graphical mapping objects, which may be added as explained below. The agent server may transform the auxiliary objects into a suitable from for downloading into an enhanced object. Without such auxiliary objects (either regular auxiliary objects or the graphical auxiliary objects described below), there is no point in using enhanced objects in the first place.

Preparation stage—Defining Region Mapping & Actions Object

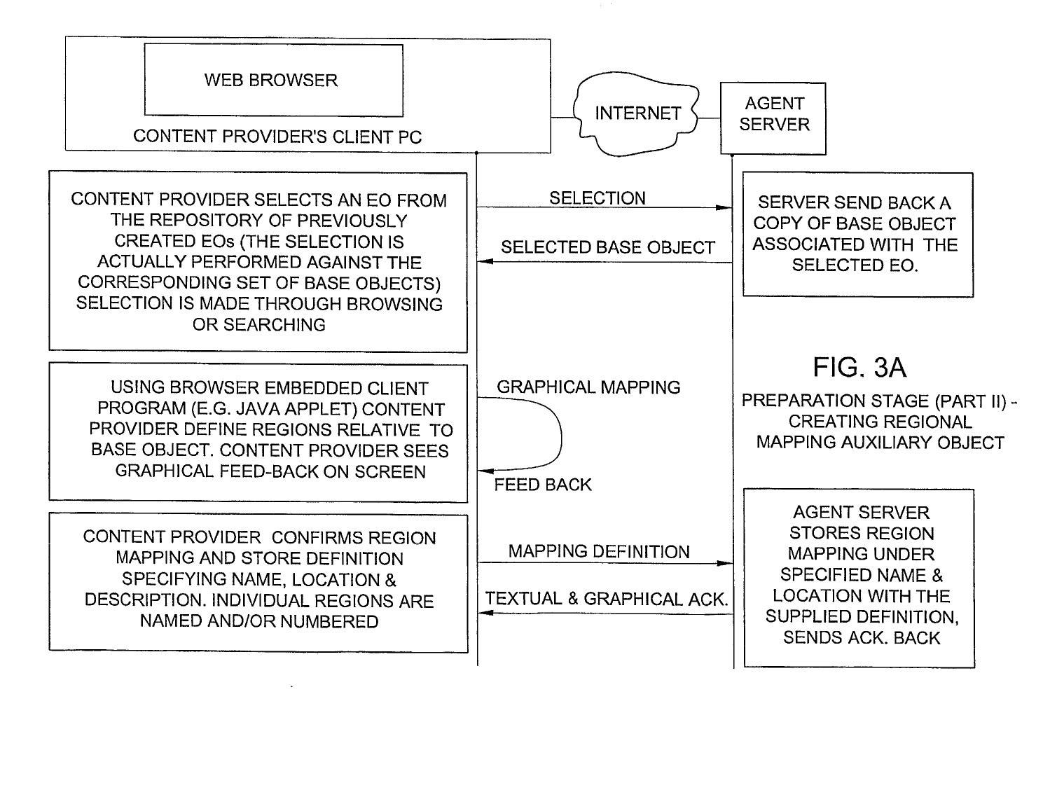

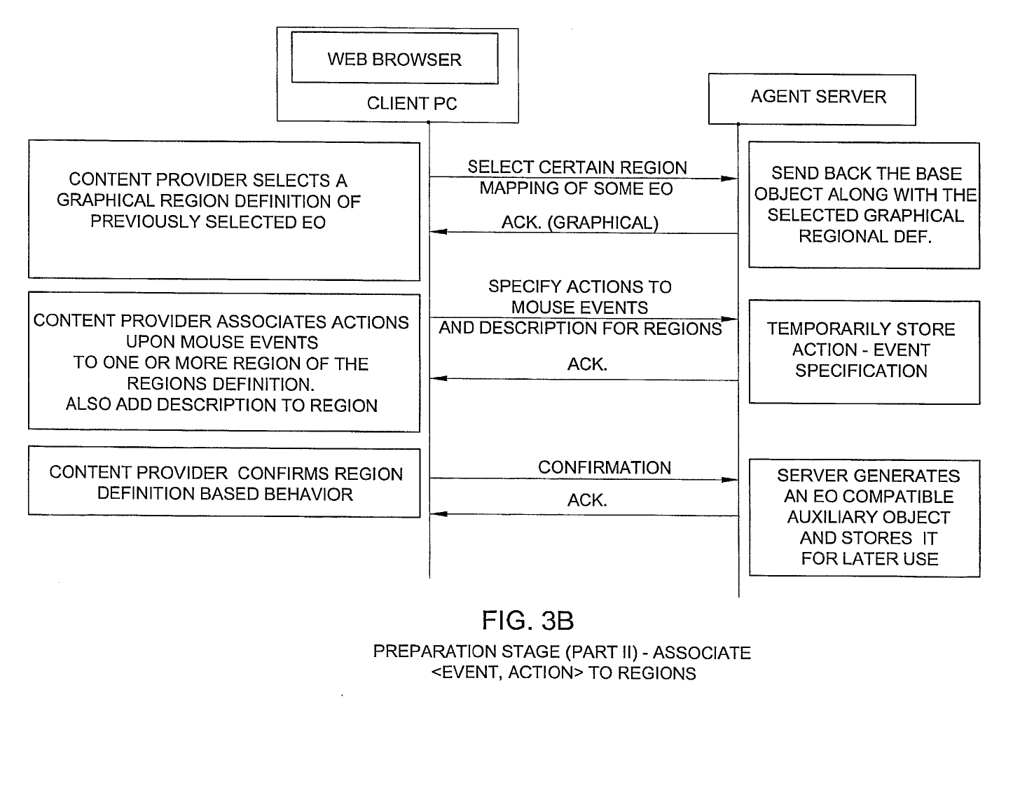

The following description relates to FIGS. 3a and 3b, wherein it will be assumed that the base object is either a still image or a docking/stopping frame of some animation/video clip

Immediately after creating the enhanced object or at any later time, the Content Provider can define graphical regions mapping to be associated with an enhanced object. This region mapping will subsequently be used to define actions to be performed as a result of user initiated mouse events on these regions. Finally, the graphical region definition together with its associated behavior is converted into a playable interactive visual object. This object is termed an Auxiliary Object, much the same as any additional playable object (such as an advertisement) is termed so to denote that it is auxiliary to the enhanced object which may load it at later time. However; these region-mapping objects are different from regular auxiliary objects in one aspect of their additional role as is explained below with particular reference to FIG. 3b of the drawings.

Interacting with the agent server through a web browser, the Content Provider; therefore, selects an enhanced object (for which the Content Provider has permission to do so) through either searching or browsing. In order to let the Content Provider define the regions, the agent server downloads into the Content Provider's browser a copy of the base object that has been stored in the agent server database for the enhanced object in question. Also downloaded to the Content Provider is a special graphical client program. The Content Provider then graphically defines one region after the other (region no. 1, region no. 2, . . . region no. N). Each region is a set of possibly single closed contours defined relative to the base object. When the Content Provider defines the contours, graphical feedback is constantly given on the Content Provider's display by the client program loaded therein. As soon as the Content Provider approves the definition, it is stored on the agent server. The Content Provider can then continue to augment this definition by supplying <region, event, action> triplets. In this triplet, “region” is region 1, 2, . . . or N from the regions defined earlier; “event” is a user action such as mouse-over; mouse-click (albeit not limited thereto); and “action” may be a request from the hosting program (the browser) to load a new page, or an instruction for the enhanced object to load a new auxiliary object, or just a command to show up some text. The set of events and actions described here is by no means an exhaustive list, and is presented only to give an idea of the capabilities of this technique of generating enhanced object compatible objects. Either now or later, the Content Provider can associate descriptive text (such as category tags) to each region. As soon as the Content Provider confirms the definition, the agent server generates an auxiliary object in the form of an Enhancement Enabler object and stores it in its Database with an association to the enhanced object. The Content Provider may define more than one such regional mapping object in regard to a single enhanced object, but the Content Provider must select only one (if any) such regional mapping to be considered as the primary graphical mapping associated with the enhanced object. At any point, the Content Provider can alter which graphical mapping object is to be considered the primary.

The way the graphical regions are defined as described above is not central to the invention. It is only described here in order to give more sense to how the invention can be used in practice.

Preparation stage—Object Matching

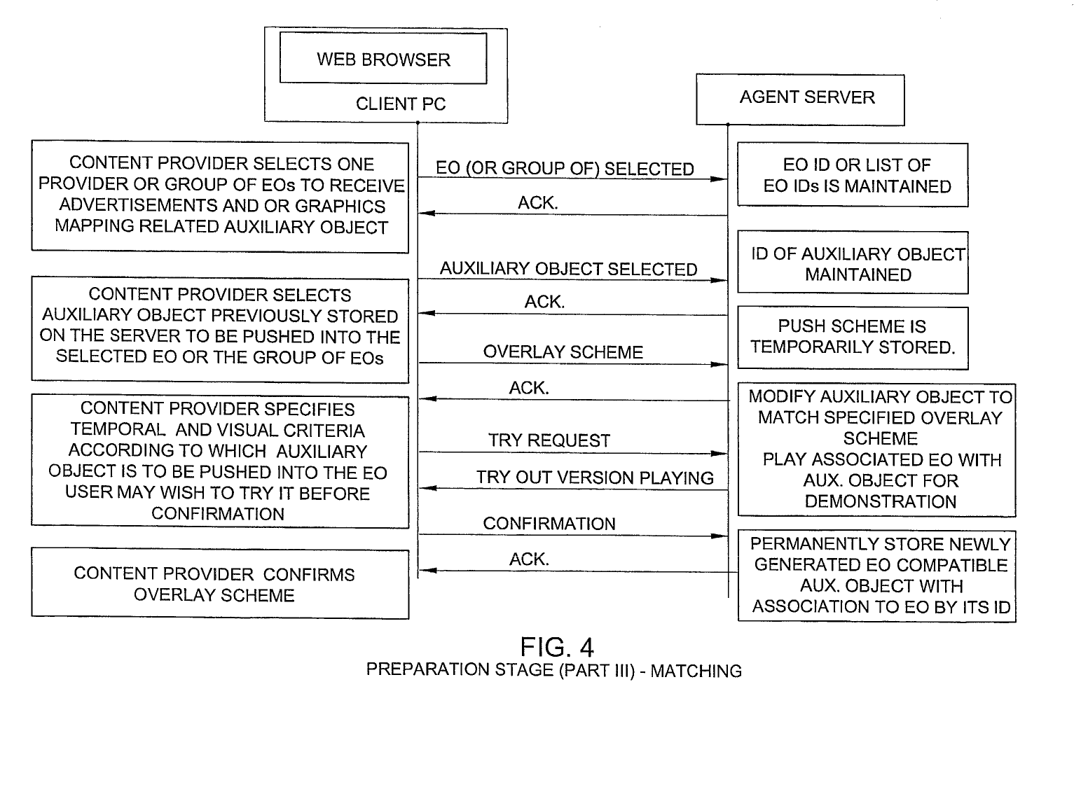

FIG. 4 shows a subsequent stage where the Content Provider actually designs the scheme of operation of the enhanced object by specifying which auxiliary objects are to be transmitted to which enhanced object and according to what mules. Without this stage, when the enhanced object is played on a client's browser it will contact the agent server but nothing will be sent back in response.

Through his or her browser the Content Provider selects a group of possibly a single enhanced object as the target for the transmission of auxiliary objects. If more than one enhanced object is selected, then the transmission scheme of auxiliary object will apply to all the enhanced objects in the set.

Whilst the Content Provider may select the target enhanced objects in any fashion, two special methods of category tag based matching deserve emphasis. According to the first method, the Content Provider searches for all enhanced object that match one or all of user supplied category tags. Matching can be defined as an exact match where, for example, the tag ‘DRILL’ may be matched only by the supplied tag ‘DRILL’. Alternatively, it may be defined according to tag hierarchy where, for example, the tag ‘DRILL’ is matched by the more general tag ‘HARDWARE-TOOL’. In either case, only those enhanced objects that have these tags previously attached to them in the creation phase are selected.

The term ‘tag based matching’ used above and throughout the specification and the appended claims, refer in general to the use of Boolean matching logic including for example AND, OR, and NOT operators.

According to a second approach, the Content Provider may wish the primary region mapping (if such exists) associated with the enhanced object to participate in the matching process. In this case, the category tags supplied by the user are matched in addition to the category tags that have been associated with the primary regional mapping object, as explained above with reference to FIGS. 3a and 3b of the drawings.

The Content Provider then selects a single auxiliary object to be transmitted to the target enhanced object(s). The selected auxiliary object can be a simple auxiliary object such as animation clip (e.g. a Flash-based animated advertisement) or it can be a region mapped interactive object (such as button-based Flash object). In general, the Content Provider is now able to configure how and when the auxiliary object should be transmitted to the enhanced object(s).

Thus, for example, the Content Provider can:

Graphically or non-graphically specify how the auxiliary object is aligned relative to the enhanced object (e.g. both objects can be aligned at their respective bottom left corners);

Specify whether the transmitted auxiliary object should move around some path inside the enhanced object graphics region (e.g. the auxiliary object's clip may be moved from top of the enhanced object frame to the bottom alignment point);

Specify whether or not while transmitting an auxiliary object, a reference effect to a portion of the enhanced object's base object should be performed (and what type of reference effect to use). For example, suppose a motor vehicle manufacturer wishes to advertise a particular make of headlamp. In this case, the reference effect can be that, in an displayed image of one of their vehicles, the headlamps blink prior to downloading text. To enable reference effects, the primary region mapping object is used (if this does not exist, no reference effect can be defined). The Content Provider selects a region in the region mapping of the base object and a reference effect. When the selected auxiliary object is transmitted to the enhanced object, a graphical effect will be produced on, or relative to, the region selected in the primary mapping object. For example, suppose the base object is an image of a person doing some drilling. Suppose further that one of the regions in the primary region-mapping object associated with the enhanced object is depicted around the drill. Further, assume that the user wants to transmit all advertisement about some drill tool manufacturer. Then, if the drill region is selected, when the chill advertisement is shown in the enhanced object, according to the effect selected, the drill in the base object may be circled for a few seconds, or a line can be drawn from the drill to the drill advertisement etc.

Specify a graphical effect that the base object embedded in the enhanced object should undergo at the time the auxiliary object is transmitted into the enhanced object. In this context, “base object” refers to the object currently rendered at the client machine by the enhanced object.

For example, the graphical effect can be constituted by resizing the base object to a different size (the base object's content is scaled appropriately) and, thereafter moving it to a specified location within the enhanced object frame.

Another particular case is when the graphical effect is making the base object translucent to a specified Alpha degree (Alpha ranges from 0% to 100%).

Another particular case is when the graphical effect is rotating the base object.

Another particular case is when the graphical effect is a combination of one or more of the above effects.

All of the above effects can also be applied to the auxiliary object.

Specify a temporal effect that governs the transmission of the auxiliary object.

For example, the temporal effect may be the starting date and time and the ending date and time that this auxiliary object should be transmitted to the enhanced object (“flying period”).

Alternatively, the temporal effect could be the amount of time that needs to elapse after the enhanced object starts playing on the client's machine before the auxiliary object is transmitted to it (the LOAD DELAY).

The temporal effect could also be the amount of time that the auxiliary object must wait before replaying in the enhanced object (looping). A value of zero indicates that no looping occurs (the LOOP DELAY).

The temporal effect can also be a series of time delays between each replay step. For example, the auxiliary object can replay after an increasing time interval in each cycle.

When an auxiliary object is selected as specified above, one of the roles of the agent server is to check for conflicts between the auxiliary object and any one of the targeted enhanced objects. A possible conflict may be due to an auxiliary object's size being larger than any of a target enhanced object. The agent server may suggest remedies (such as clipping an auxiliary object to fit into the enhanced object size).

When the Content Provider confirms that the definition of the auxiliary object transmission scheme is complete, the agent server builds the appropriate enabled object-compatible auxiliary object that will be pulled by the bootstrap Enhancement Enabler object contained in the enhanced object. The agent server stores this auxiliary object in the Database and makes the necessary association so that it can locate it once the enhanced object asks to load it. It is a matter of configuration of the agent server whether the above scheme be accomplished through a single auxiliary object or a chain of two or more auxiliary objects. In case of a single auxiliary object, it will be transmitted immediately to the enhanced object in response to the HERE-I-AM message, but will delay showing the visual content on screen as specified. In a chained version (which exploits bandwidth more efficiently), a first auxiliary object will be transmitted immediately replacing the original BOOTSTRAP Enhancement Enabler object, and will later load the real content auxiliary object. Whilst, the above mechanism refers to the initial step of running an enhanced object, it is equally true for subsequent stages of running the enhanced object.

The matching mode discussed above matches a single auxiliary object to an enhanced object. According to another mode, the Content Provider specifies a list of auxiliary objects that are to be transmitted one after the other (delayed from each other by some DELAY value). After the last auxiliary object has been transmitted to the enhanced object (providing the user at the client machine running the enhanced object stays long enough with the original page to allow all these auxiliary objects to arrive), either the last auxiliary object stays at the enhanced object or the list is cyclically restarted. It is the task of the agent server to embed the appropriate chaining mechanism in each of these auxiliary objects. An alternative is to create an auxiliary object with a list of auxiliary objects embedded therein so that it can load each of those auxiliary objects in succession.

It is evident from the above that this scheme enables different auxiliary objects to be transmitted to different enhanced objects at different times. This is also true for region mapping auxiliary objects, which makes it flexible for different clients to define different “mapping” on top of a single graphics object for different perspectives.

The above description assumes that the Content Provider is the one that created the enhanced object as well as creating and updating the auxiliary objects and also defining the matching scheme. However, according to a different business model, the Content Provider creates an enhanced object and makes it available for third parties to create and match auxiliary objects of their own (usually for a fee). Such third parties can be “brokerage servers”, which operate in a manner analogous to the Content Provider; and so are not themselves discussed in further detail.

Running Stage

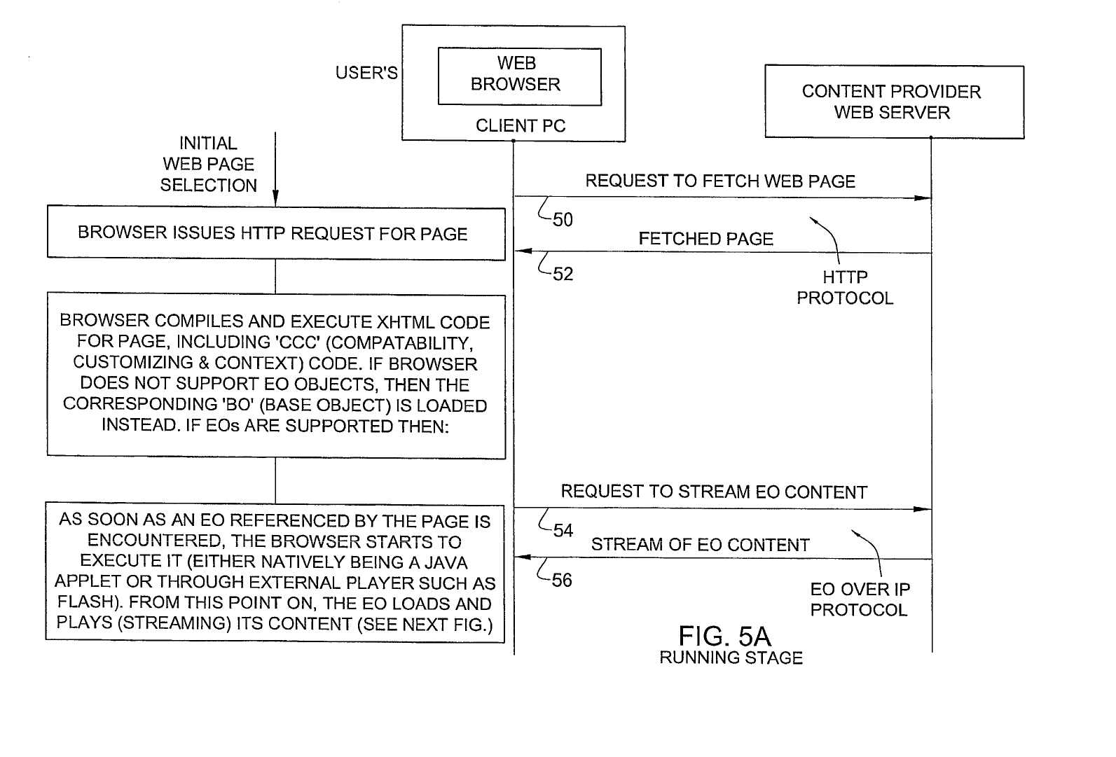

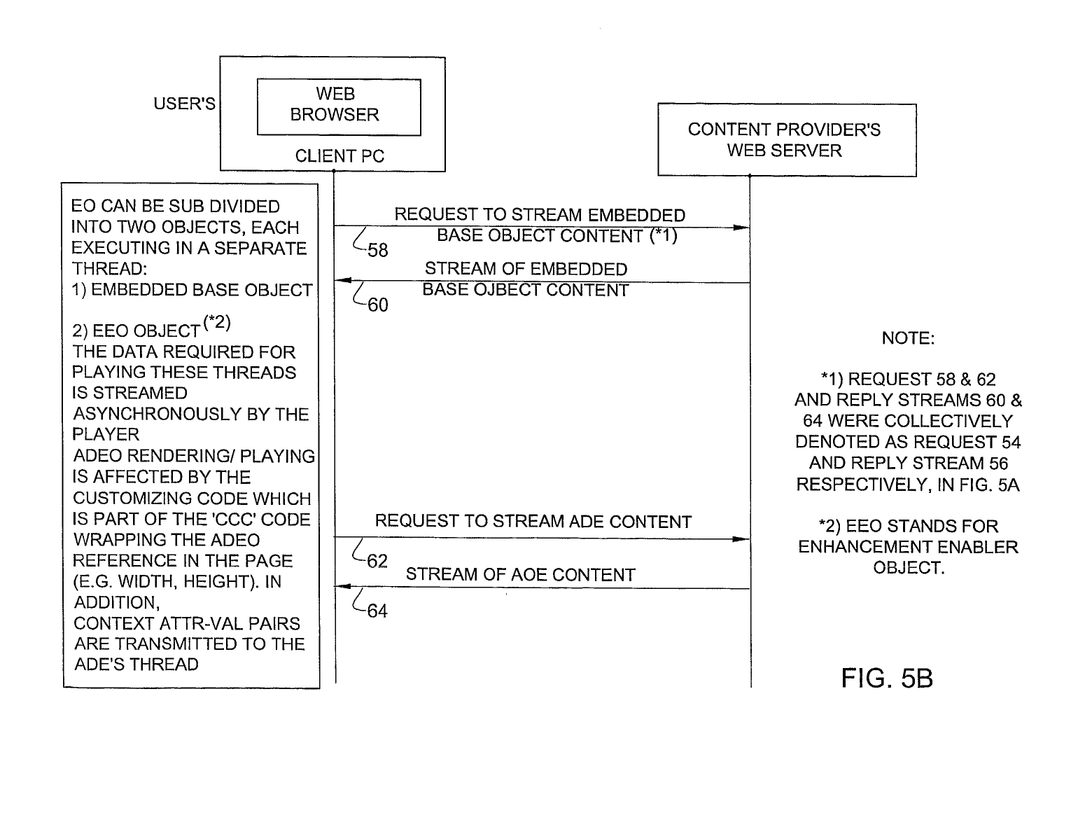

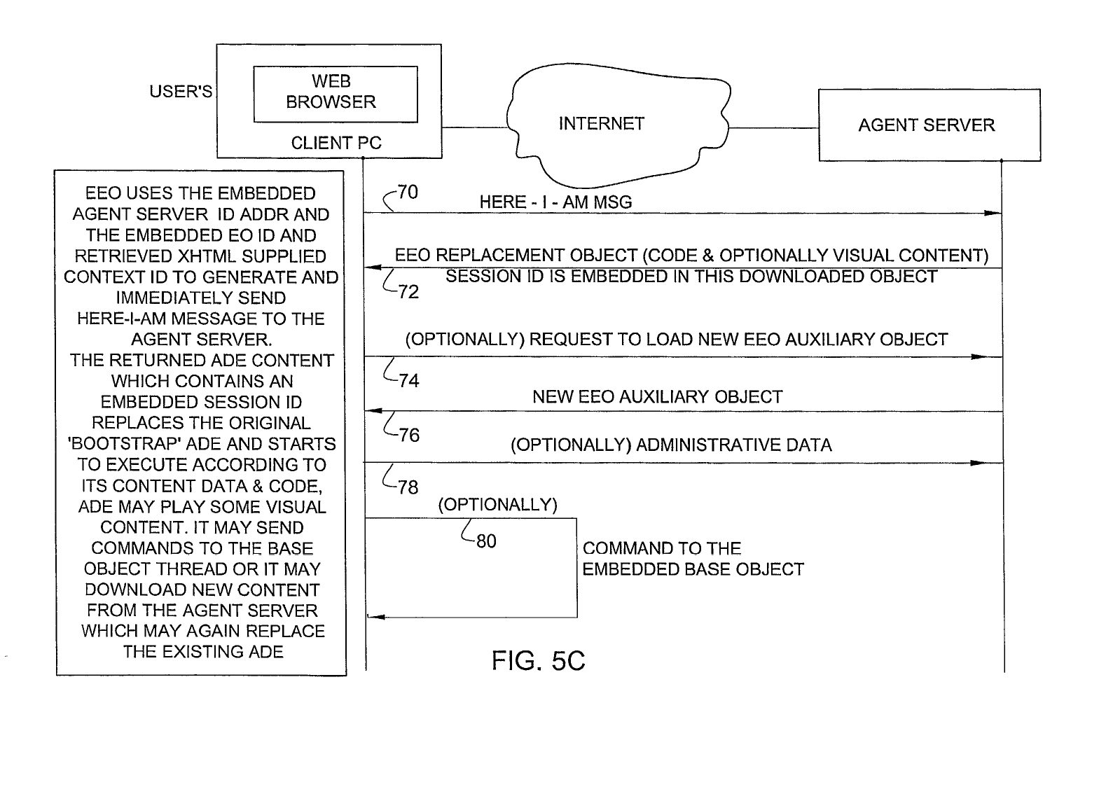

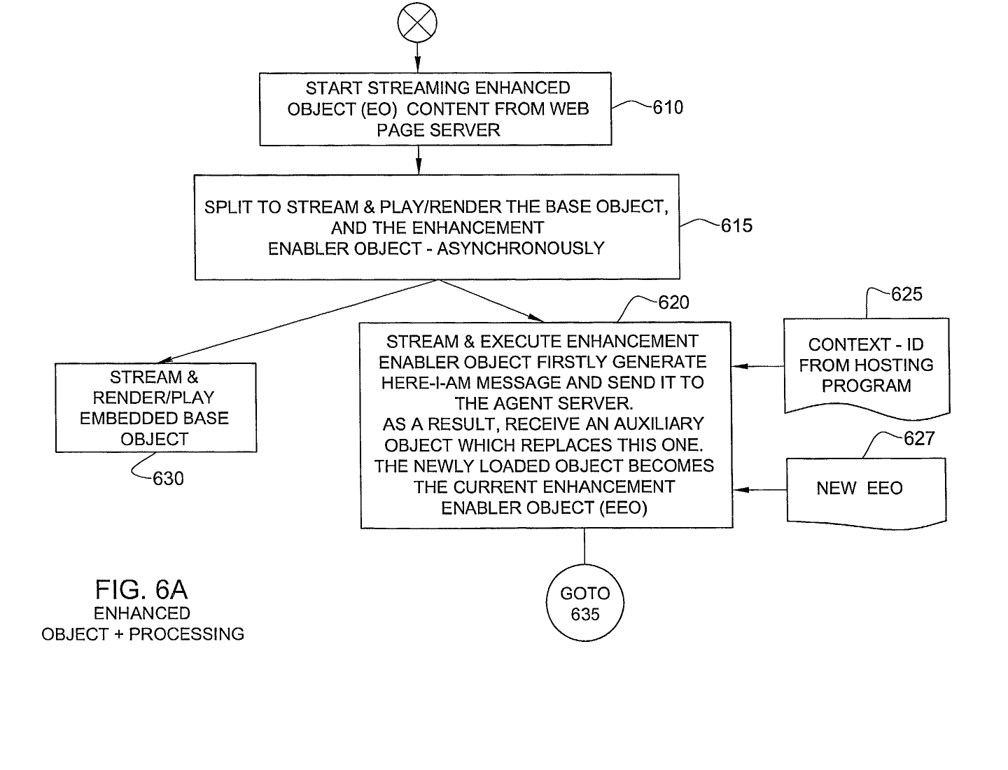

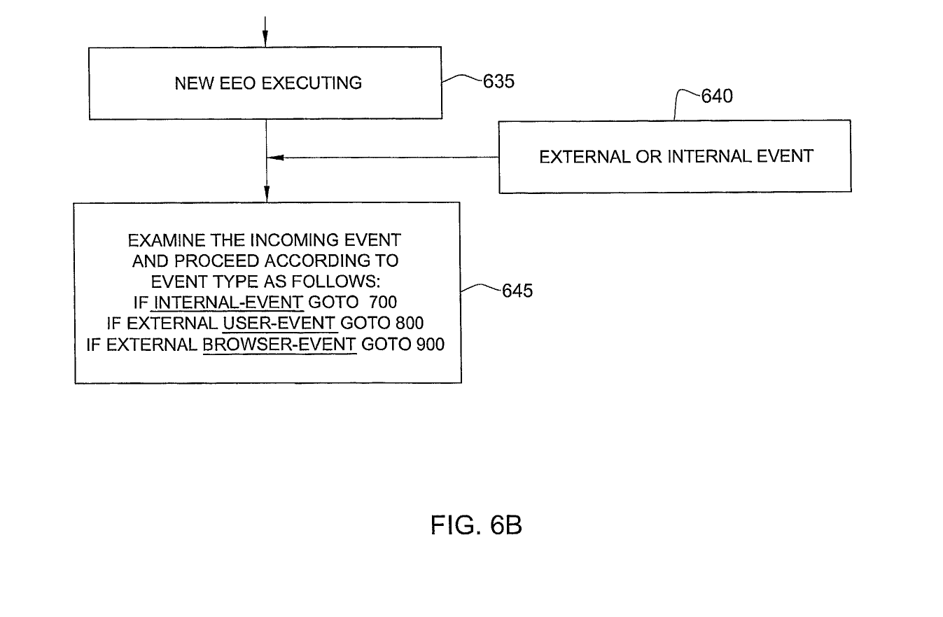

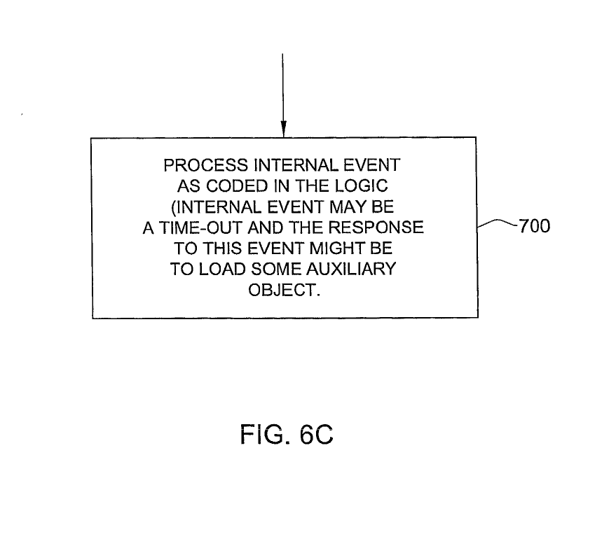

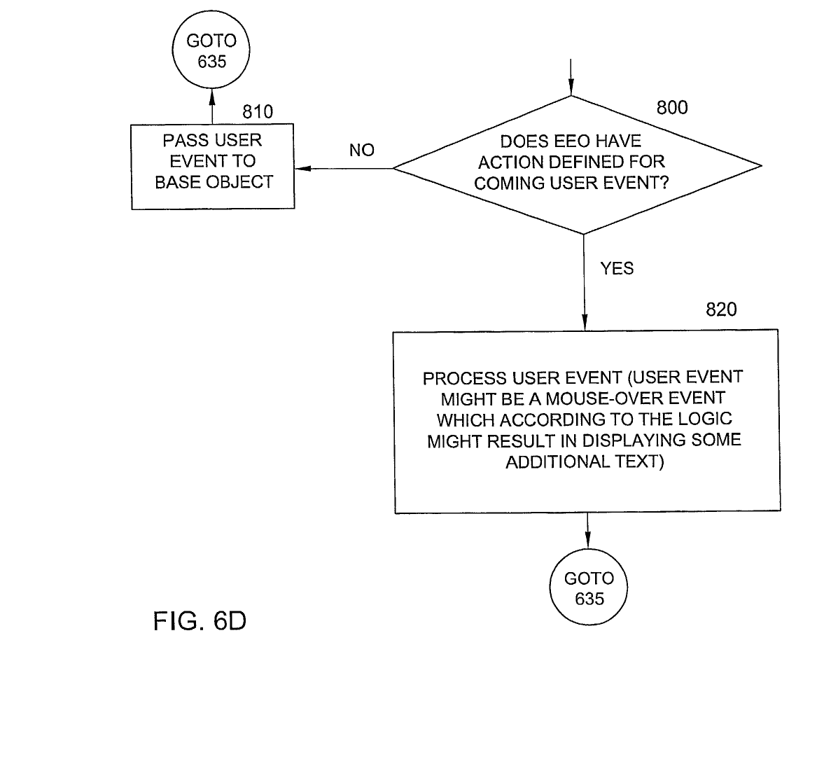

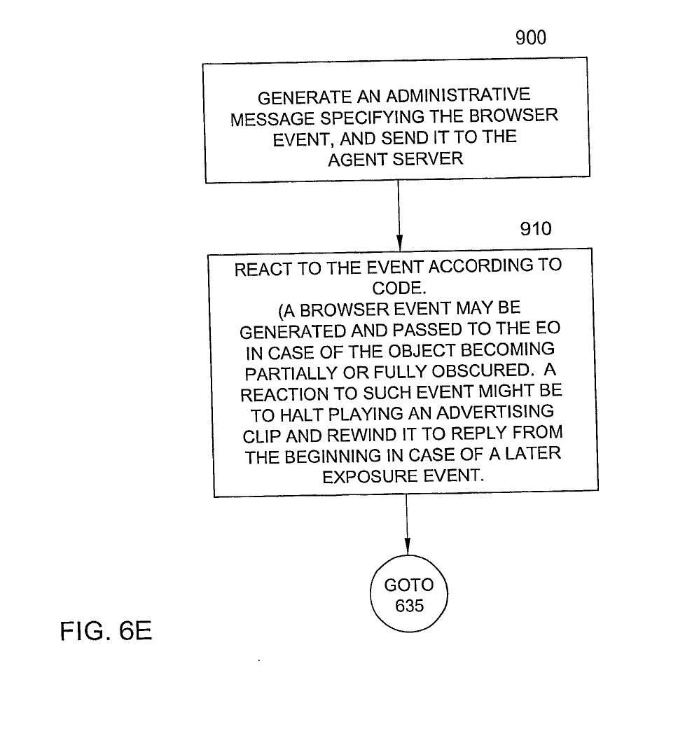

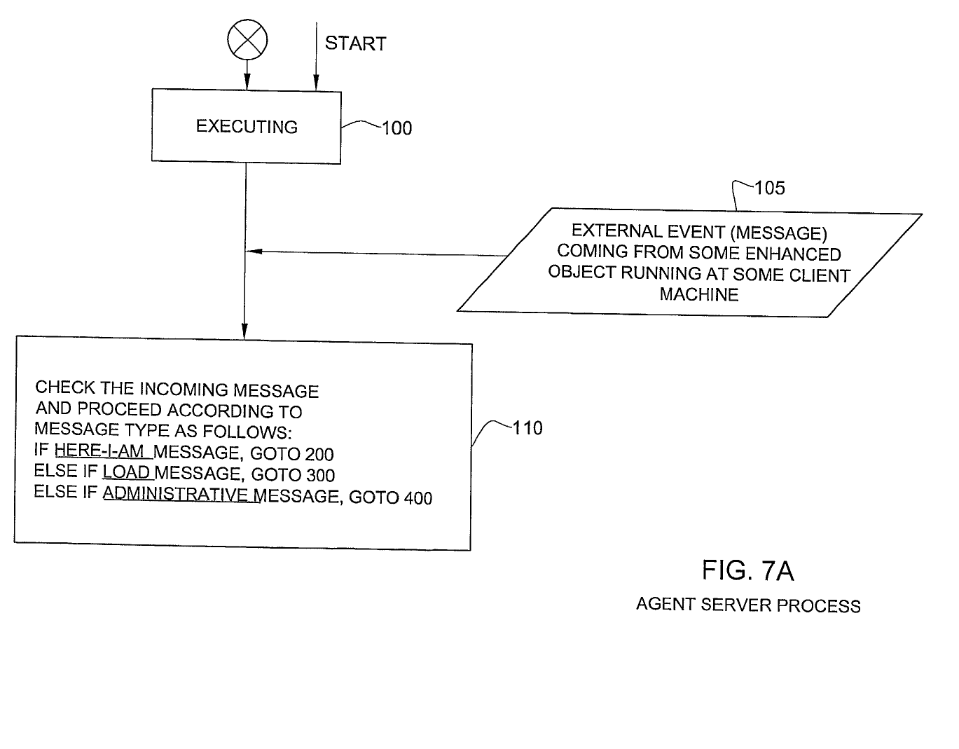

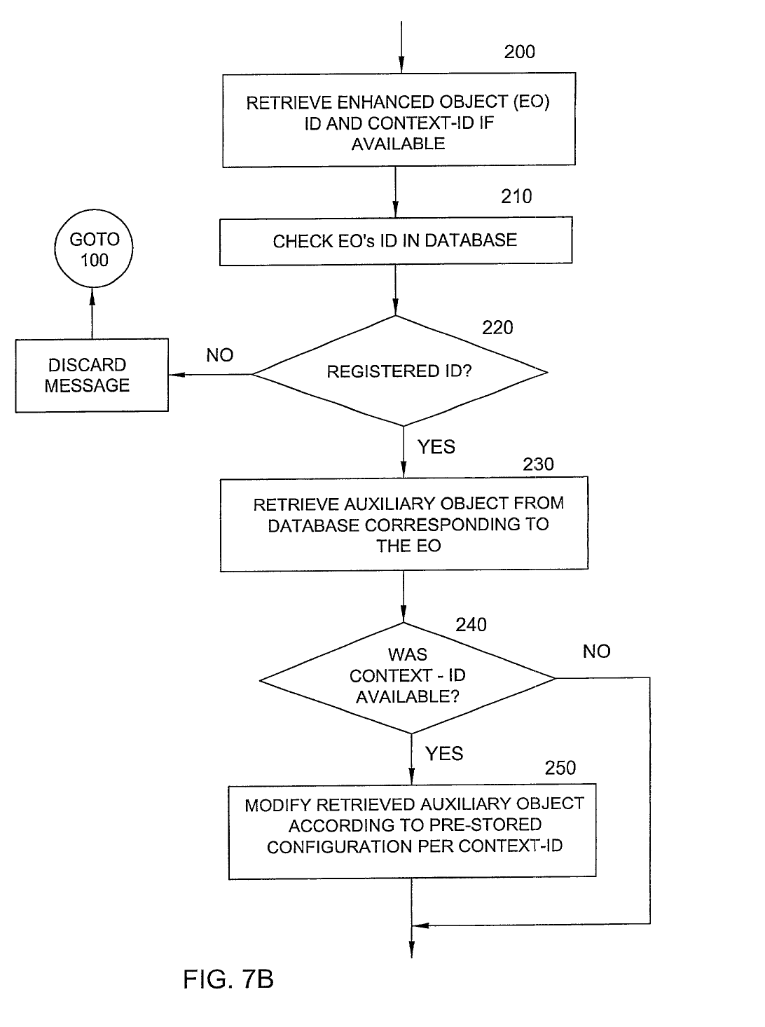

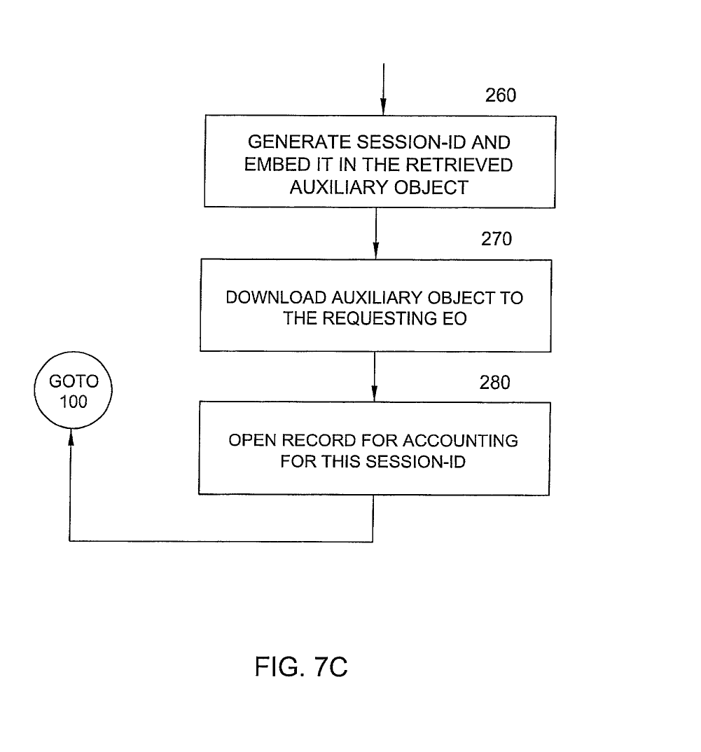

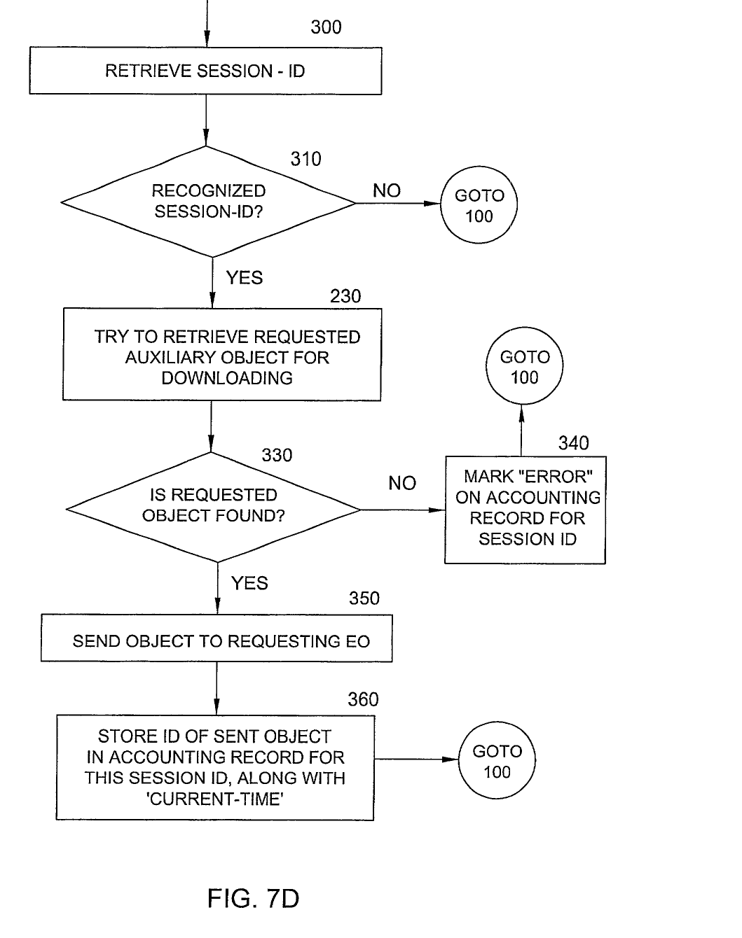

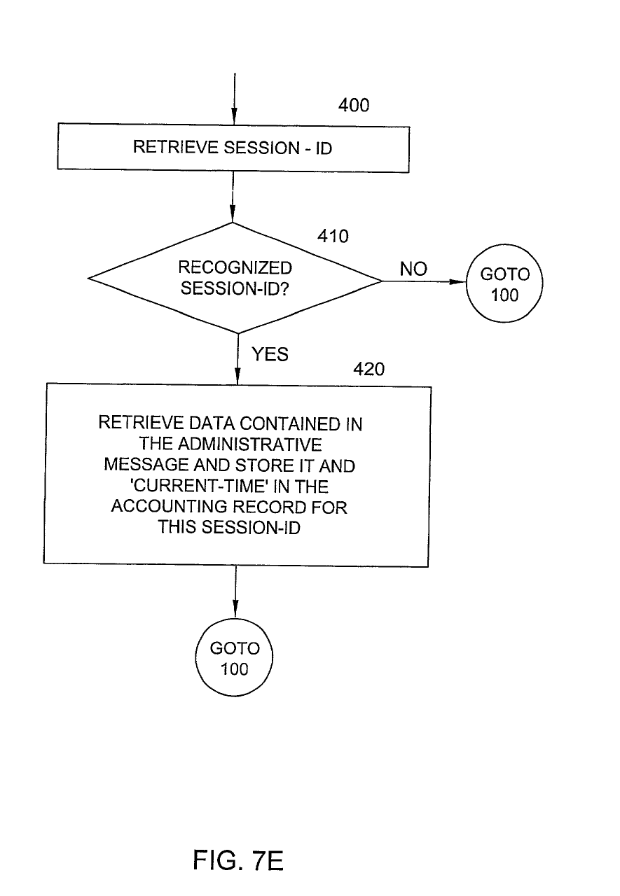

FIGS. 5a to 5c show the flow of data between an enhanced object 17 and an agent server 11 during the running stage of the enhanced object, as the enhanced object is downloaded from the Content Provider server 15 to the client machine 12. FIGS. 6a to 6e show a detailed flow diagram of the operation of the enhanced object during this session, while FIGS. 7a to 7e show a detailed flow diagram of the corresponding operation at the agent server 11. A Web page containing a reference to an enhanced object is loaded into a user's browser running on the client machine. The compatibility code is compiled and executed and, according to the browser version, it is decided whether to further load the enhanced object or to load its base object counterpart. Thus, if it is determined that the user's browser cannot read the enhanced object, the base object is loaded instead. For this reason, it is helpful if, as noted above, the base object is maintained on the agent server 11 after creating the enhanced object. When the enhanced object is finally loaded, a player plays it (either natively by the browser being a Java applet or by a special player as in the case of a Flash movie). The player streams the enhanced object's content from the same Content Provider server where the page resides. As soon as it can do so, the Enhancement Enabler object component of the enhanced object constructs and issues a HERE-I-AM message to the agent server. Meanwhile, the embedded base object is rendered/played asynchronously. To generate the HERE-I-AM message, the Enhancement Enabler object uses the embedded enhanced object ID that was prepared by the agent server when the enhanced object was created. It also uses the URL that the agent server has embedded in the enhanced object. Finally, it includes in the message the context-ID, if any, supplied to the enhanced object by the hosting program (the browser). According to one particular scheme, a short delay can be inserted between downloading and rendering the base object, so as to allow a subsequently downloaded auxiliary object to supersede the base object. By such means, the base object is not rendered and the visual effect presented to the user 19 at the client machine 12 is due only to rendering of the auxiliary object.

For example, the enhanced object may be a Flash movie and the HERE-I-AM message is a LOAD MOVIE command, where the name of the target movie is the agent server URL concatenated with both the enhanced object ID and the context ID (which the agent server is able to decipher). Alternatively, the enhanced object may be a Flash movie and the HERE-I-AM message a LOAD MOVIE command with a specification to replace the clip which issued the LOAD command with the newly loaded movie (“logic replacement”).

Upon receiving the HERE-I-AM message, the agent server references the supplied enhanced object ID in its database. If it finds it, it modifies the pre-constructed auxiliary object for that enhanced object by embedding in it a newly generated session ID. As soon as this new auxiliary object is sent back to the enhanced object, the agent server opens an accounting record for this session.

The newly loaded auxiliary object on the client's machine starts to play, making the visual effects that it was authored to do. Amongst other things, it might transmit commands to the embedded base object to undergo some graphical transformations. Thus, in a particular case, the enhanced object is a Flash movie, the embedded base object is an internal Flash clip and the command to the embedded base object is a Flash Set Property command. According to code embedded therein, the Enhancement Enabler object may issue a load command to the agent server requesting to load a new auxiliary object which will in turn replace the calling Enhancement Enabler object. The Enhancement Enabler object may also issue administrative commands to the agent server such as a STILL-HERE timer command (which will be used to measure how much time the object was running). Other examples include issuing a log command summarizing user interaction or loading an auxiliary object from the agent server. The Enhancement Enabler object may further directly react to mouse events or it may pass them to be handled by the embedded base object.

In a particular case, the enhanced object is a Flash movie and the STILL-HERE and the LOG messages are Flash Remote Set Value commands, (the mechanism that enables a Flash movie to implement a form and pass values to a remote Web server) and the session ID is concatenated to each of the values sent.

Upon receiving either an administrative message or request for loading command, the agent server deciphers the session ID embedded in the message. According to this ID, it can modify the accounting record by storing, for example, what command was received at what time. In the case of a load command, an auxiliary object can be a simple object whereby the Enhanced Enabler Object will not be replaced by this auxiliary object and is only rendered or displayed. Alternatively, the auxiliary object may itself be an Enhanced Enabler Object, in which case it replaces the calling Enhanced Enabler Object.

Another matching criterion to be added is a user profile, for example a cookie that is supplied to the agent server by a third party web site to which the user 19 logs on. This allows preparation of an enhanced object to serve for downloading different pictures according to a predetermined profile of the surfer. For example, a first surfer who surfs a vehicle manufacturer's site will be presented with an advertisement for tires; a second surfer will be presented an advertisement for headlamps and a third will be presented an advertisement for windshield wipers, all according to the respective profiles of the different surfers as well as tags embedded in the enhanced object.

In the network 10 shown in FIG. 1, the user 19 operates a web application running on the client machine 12, such as AOL's Netscape or Microsoft Internet Explorer, to generate through the hypertext transfer protocol (HTTP) a request to download a page 16 from the Content Provider server 15 having a reference to at least one Enhanced Object 17. The Content Provider server 15 sends one or more messages back using the same protocol. These messages preferably contain all the information available on the Content Provider server 15 for the requested page 16, and in particular the enhanced object 17, to be displayed by the user's browser. As soon as the enhanced object 17, running in the user's browser environment can do so, it generates, through a customized enhanced object protocol, an identification message to the agent server in which it was registered. The agent server sends back a single message containing a session ID and new logic that replaces the initial logic of the enhanced object 17. According to the settings of the agent server; it may generate, through the enhanced object over IP protocol, a forwarding message, passing the enhanced object's identification message content to another agent server. This server, in turn, may continue forwarding this message on to yet another agent server. The last agent server in the cycle sends back a message through the enhanced object protocol directly to the enhanced object 17. Subsequently, as scheduled by the enhanced object's loaded logic, the enhanced object 17 sends requests to load auxiliary objects which are responded to by the requested auxiliary objects being sent back (both these two messages are sent through the enhanced object protocol). The requests by the enhanced object and the corresponding responses may be repeated as scheduled by the enhanced object's logic.

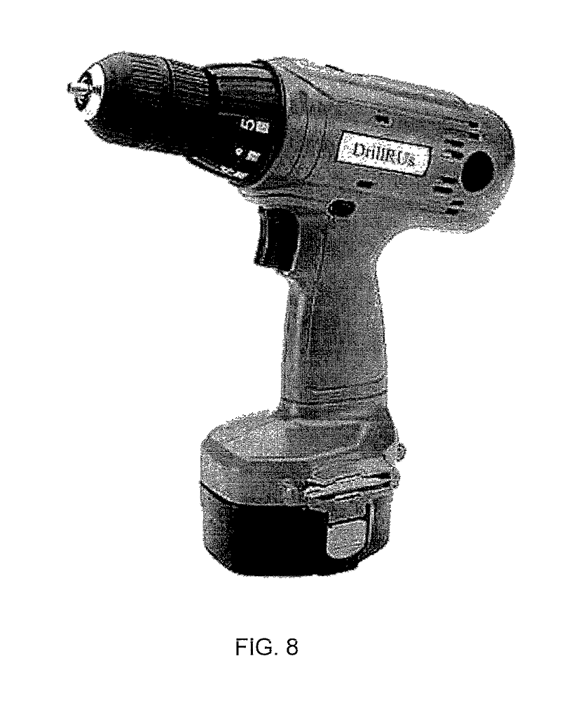

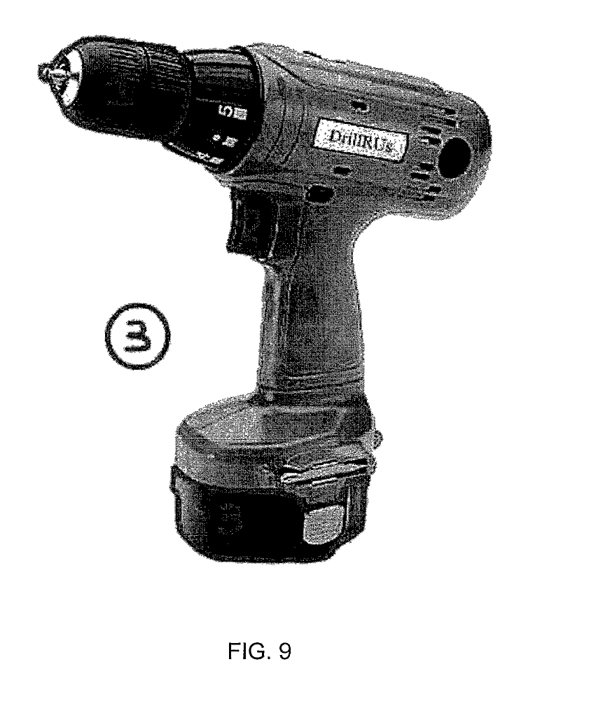

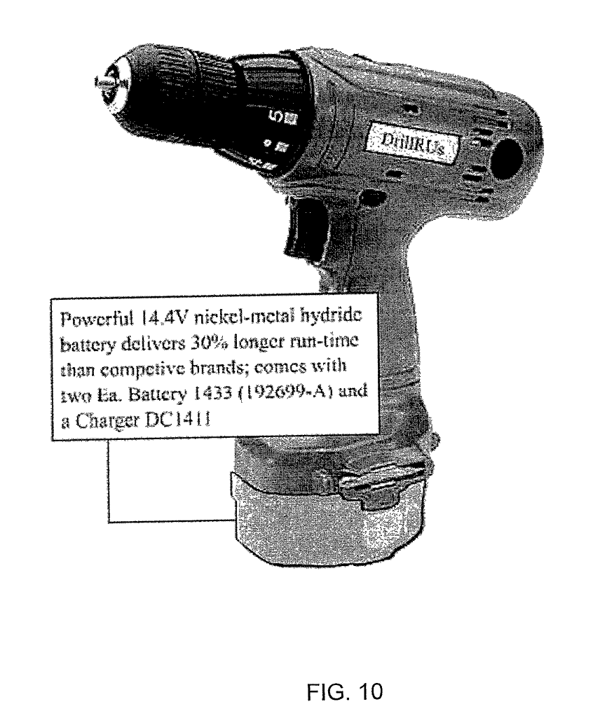

FIG. 8 is a visual image of a drill, constituting a base object 30, downloaded from the web site of the drill manufacturer DrillUs. FIG. 9 shows an enhanced object 31 including regional mapping 32 as externally defined for the base object 30 and maintained on an agent server. The mapping 32 contains three regions labeled 1, 2 and 3. For region number 3, there is defined a location (denoted by the number 3 inside a circle) for displaying a explanatory material In addition, a mouse-over triggered action has been defined for that region specifying that certain text (also supplied) should be displayed. The display of the enhanced object 31 during the activation of this action is shown in FIG. 10.

FIG. 10 shows the enhanced object 31 during a mouse-over inside region number 3 (the region which occupies the drill's base battery as shown in FIG. 9). The coloring of the region, as well as producing the colored text box and the reference arrows were all generated automatically by the enhanced object 31 using the code that was automatically generated by the agent server when the region mapping 30 was defined.

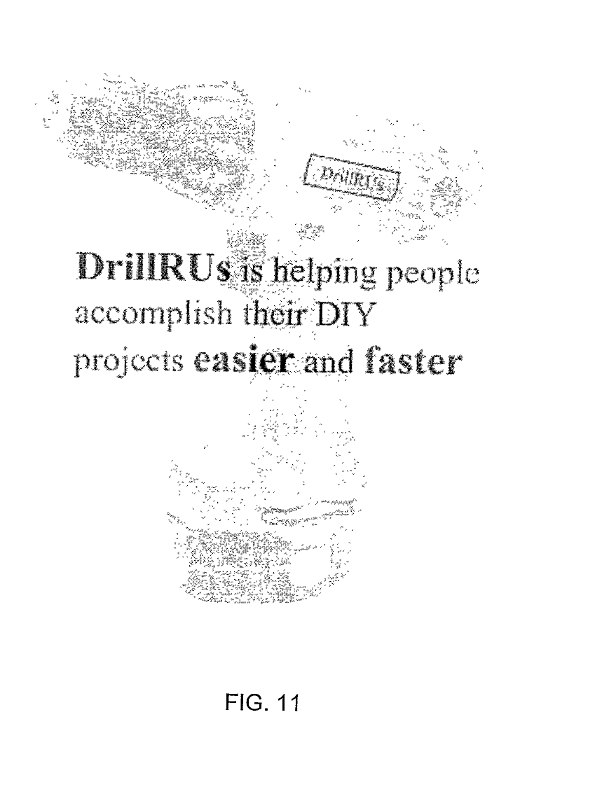

FIG. 11 shows the enhanced object 31 as it is rendered during a display of an externally streamed textual advertisement 33. The base object 30 is temporarily made translucent and is brought to normal opaqueness some time later as the advertisement will disappear. In this case, the content provider specified only the text, and specified that it should be centered relative to the base object 30. The content provider further specified the insertion effect (the ad should reflect through a translucent base image) as well as the amount of time to show the advertisement. The actual displaying of the ad, its insertion effect, and its positioning are all automatically arranged and coded by the agent server into the enhanced auxiliary data that was later loaded into, and took effect in, the original enhanced object 31.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A computer-implemented method for downloading a customized base object to a client machine, said method including the following steps all carried out by a Content Provider web server:
(a) obtaining an enhanced object created from the base object, said enhanced object having associated therewith an identification for allowing an agent web server to uniquely identify said enhanced object, and having embedded therein program code for effecting communication with the agent web server, and
(b) downloading to a client machine an XHTML page containing a reference to the enhanced object so as to allow activation of said program code by the client machine and thereby to call the agent web server, so as to allow the agent web server to download auxiliary data to the client machine in predetermined association with the enhanced object within a boundary thereof.

2. The method according to claim 1, wherein the base object is a graphical object.

3. The method according to claim 1, wherein the auxiliary data includes graphical data.

4. The method according to claim 1, wherein the auxiliary data includes replacement program code for replacing the program code in the enhanced object.

5. The method according to claim 1, wherein the auxiliary data is an advertisement.

6. The method according to claim 1, wherein the auxiliary data includes graphical mapping and explanatory material.

7. The method according to claim 1, wherein the auxiliary data is selected by the agent web server according to a subject matter associated with the enhanced object.

8. The method according to claim 1, wherein the agent web server and the source web server are identical.

9. The method according to claim 1, wherein the base object is a still image.

10. The method according to claim 1, wherein the base object is a dynamic image containing at least one frame which remains stationary pending user interaction.

11. The method according to claim 10, wherein the dynamic image is a video clip or an animation clip.

12. A computer-implemented method for generating an enhanced object from a base object, said method including the following steps all carried out by an agent web server:
(a) creating a containment object,
(b) associating with the containment object an identification for allowing the agent web server to uniquely identify the enhanced object, and
(c) generating the enhanced object by embedding in the containment object or in an object derived therefrom, program code for effecting communication with the agent web server, so as to allow the agent web server to download auxiliary data to a client machine running the enhanced object in predetermined association with the enhanced object within a boundary thereof.

13. The method according to claim 12, further including:
(d) downloading the enhanced object to a content provider for referencing within an XHTML page provided by the content provider.

14. The method according to claim 12, further including:
(e) storing at least one auxiliary object for downloading to the client machine in association with the enhanced object.

15. The method according to claim 13, further including:
(f) storing at least one auxiliary object for downloading to the client machine in association with the enhanced object.

16. A computer-implemented method for rendering an enhanced object customized from a base object, said method including the following steps all carried out by the enhanced object:
(a) effecting communication with an agent web server referenced within the enhanced object, and
(b) downloading from the agent web server auxiliary data in predetermined association with the enhanced object within a boundary thereof.

17. The method according to claim 16, wherein step (b) includes:
i) determining whether a web browser resident on a host client machine is adapted to render the auxiliary data and, if not,
ii) downloading the base object from the Content Provider web server.

18. A Content Provider web server adapted for downloading a customized base object to a client machine, said Content Provider web server including:
a first communication channel for obtaining an enhanced object created from the base object, said enhanced object having associated therewith an identification for allowing an agent web server to uniquely identify said enhanced object, and having embedded therein program code for effecting communication with the agent web server, and
a second communication channel for downloading to a client machine an XHTML page containing a reference to the enhanced object so as to allow activation of said program code by the client machine and thereby to call the agent web server, so as to allow the agent web server to download auxiliary data to the client machine in predetermined association with the enhanced object within a boundary thereof.

19. The Content Provider web server according to claim 18, wherein the base object is a graphical object.

20. The Content Provider web server according to claim 18, wherein the auxiliary data includes graphical data.

21. The Content Provider web server according to claim 18, wherein the auxiliary data includes replacement program code for replacing the program code in the enhanced object.

22. The Content Provider web server according to claim 18, wherein the auxiliary data is an advertisement.

23. The Content Provider web server according to Claim -18, wherein the auxiliary data includes graphical mapping and explanatory material.

24. The Content Provider web server according to claim 18, wherein the auxiliary data is selected by the agent web server according to a subject matter associated with the enhanced object.

25. The Content Provider web server according to claim 18, wherein the agent web server and the source web server are identical.

26. The Content Provider web server according to claim 18, wherein the base object is a still image.

27. The Content Provider web server according to claim 18, wherein the base object is a dynamic image containing at least one frame which remain-s stationary pending user interaction.

28. The Content Provider web server according to claim 27, wherein the dynamic image is a video clip or an animation clip.

29. An agent web server adapted for generating an enhanced object from a base object, said agent web server including a processor adapted to:
(a) create a containment object,
(b) associate with the containment object an identification for allowing the agent web server to uniquely identify the enhanced object, and
(c) generate the enhanced object by embedding in the containment object or in an object derived therefrom, program code for effecting communication with the agent web server, so as to allow the agent web server to download auxiliary data to a client machine running the enhanced object in predetermined association with the enhanced object within a boundary thereof.

30. The agent web server according to claim 29, wherein the processor is further adapted to:
download the enhanced object to a content provider for referencing within an XHTML page provided by the content provider.

31. The agent web server according to claim 29, wherein the processor is further adapted to:
(d) store at least one auxiliary object for downloading to the client machine in association with the enhanced object.

32. An enhanced object customized from a base object, said enhanced object being adapted to:
(a) effect communication with an agent web server referenced within the enhanced object, and
(b) download from the agent web server auxiliary data in predetermined association with the enhanced object within a boundary thereof.

33. The enhanced object according to claim 32, being adapted to:
(c) determine whether a web browser resident on a host client machine is adapted to render the auxiliary data and, if not,
(d) download the base object from the Content Provider web server.

34. A computer-implemented program storage device readable by machine, tangibly embodying a program of instructions executable by the machine to perform method steps for downloading a customized base object to a client computer, said method including the following steps:
(a) obtaining an enhanced object created from the base object, said enhanced object having associated therewith an identification for allowing the machine to uniquely identify said enhanced object, and having embedded therein program code for effecting communication with an agent web server, and
(b) downloading to a client computer an XHTML page containing a reference to the enhanced object so as to allow activation of said program code by the client computer and thereby to call the agent web server, so as to allow the agent web server to download auxiliary data to the client computer in predetermined association with the enhanced object within a boundary thereof.

35. A computer-implemented computer program product comprising a computer useable medium having computer readable program code embodied therein for downloading a customized base object to a client computer, said computer program product comprising:
computer readable program code for causing the computer to obtain an enhanced object created from the base object, said enhanced object having associated therewith an identification for allowing an agent web server to uniquely identify said enhanced object, and having embedded therein program code for effecting communication with the agent web server, and
computer readable program code for causing the computer to download to a client computer an XHTML page containing a reference to the enhanced object so as to allow activation of said program code by the client computer and thereby to call the agent web server, so as to allow the agent web server to download auxiliary data to the client computer in predetermined association with the enhanced object within a boundary thereof.

36. A computer-implemented program storage device readable by machine, tangibly embodying a program of instructions executable by the machine to perform method steps for generating an enhanced object from a base object, said method including the following steps:
(a) creating a containment object,
(b) associating with the containment object an identification for allowing the machine to uniquely identify the enhanced object, and
(c) generating the enhanced object by embedding in the containment object or in an object derived therefrom, program code for effecting communication with the machine, so as to allow the machine to download auxiliary data to a client computer running the enhanced object in predetermined association with the enhanced object within a boundary thereof.

37. A computer-implemented computer program product comprising a computer useable medium having computer readable program code embodied therein for generating an enhanced object from a base object, said computer program product comprising:
computer readable program code for causing the computer to create a containment object,
computer readable program code for causing the computer to associate with the containment object an identification for allowing the computer to uniquely identify the enhanced object, and
computer readable program code for causing the computer to generate the enhanced object by embedding in the containment object or in an object derived therefrom, program code for effecting communication with the machine, so as to allow the computer to download auxiliary data to a client computer running the enhanced object in predetermined association with the enhanced object within a boundary thereof.

38. A computer-implemented program storage device readable by machine, tangibly embodying a program of instructions executable by the machine to perform method steps for rendering an enhanced object customized from a base object, said method including the following steps:
(a) effecting communication with an agent web server referenced within the enhanced object, and
(b) downloading from the agent web server auxiliary data in predetermined association with the enhanced object within a boundary thereof.

39. A computer-implemented computer program product comprising a computer useable medium having computer readable program code embodied therein for rendering an enhanced object customized from a base object, said computer program product comprising:
computer readable program code for causing the computer to effect communication with an agent web server referenced within the enhanced object, and
computer readable program code for causing the computer to download from the agent web server auxiliary data in predetermined association with the enhanced object within a boundary thereof.
